(19) United States
(12) Patent Application Publication
(10) Pub. No.: US 2015/0365798 A1
(43) Pub. Date: Dec. 17, 2015

(54) METHOD AND APPARATUS FOR PROVIDING BROADCAST OR MULTICAST OF DIGITAL CONTENT IN A CELLULAR COMMUNICATIONS NETWORK

(71) Applicant: Telefonaktiebolaget L M Ericsson (publ), Stockholm (SE)

(72) Inventors: Chris MCEVILLY, Bagshot (GB); Daniel MOLANDER, Bromma (SE)

(73) Assignee: TELEFONAKTIEBOLAGAET L M ERICSSON (PUBL), Stockholm (SE)

(21) Appl. No.: 14/764,539

(22) PCT Filed: Jan. 30, 2013
(86) PCT No.: PCT/EP2013/051766

§ 371 Date: Jul. 29, 2015

(51) Int. Cl. H04W 4/02; H04W 4/06; H04L 12/825; H04L 12/18

(52) U.S. Cl. CPC H04W 4/022; H04L 12/18; H04W 4/06; H04W 4/028; H04L 47/25

(57) ABSTRACT

A method in and a communication node for providing a digital content to at least one wireless device in a cellular communications network. The communication node obtains information identifying the digital content. The digital content is associated with a moving demand area being an area that changes location over time according to a movement pattern and in which area a demand for the digital content has been identified to move with the area. The communication node provides, based on the obtained information, a broadcast or multicast of the digital content in a provision area comprising the moving demand area. The provision area corresponds to one or more cells served by one or more base stations broadcasting or multicasting the digital content. The provided broadcast or multicast is adapted based on the movement pattern.

### TECHNICAL FIELD

Embodiments herein relate to a method in a communication node and a communication node. In particular embodiments herein relate to providing a digital content to at least one wireless device in a cellular communications network.

### BACKGROUND

Communication devices such as wireless devices are also known as e.g. user equipments (UEs) mobile terminals, wireless terminals and/or mobile stations (MS). A wireless device is enabled to communicate wirelessly in a cellular communications network, wireless communications network, wireless communications system, or radio communications system, sometimes also referred to as a cellular radio system or cellular network. The communication may be performed e.g. between two wireless devices, between a wireless device and a regular telephone and/or between a wireless device and a server via a Radio Access Network (RAN) and possibly one or more core networks, comprised within the cellular communications network.

The wireless device may further be referred to as a mobile telephone, cellular telephone, smart phone, laptop, Personal Digital Assistant (PDA), tablet computer, surf plate, just to mention some further examples. The wireless device in the present context may be, for example, portable, pocket-storable, hand-held, computer-comprised, or vehicle-mounted mobile device, enabled to communicate voice and/or data, via the RAN, with another entity, such as another wireless device or a server.

The cellular communications network covers a geographical area which is divided into cell areas, wherein each cell area being served by a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. By the base station serving a cell is meant that the radio coverage is provided such that one or more wireless devices located in the geographical area where the radio coverage is provided may be served by the base station. One base station may serve one or several cells. Further, each base station may support one or several communication technologies. The base stations communicate over the air interface operating on radio frequencies with the wireless device within range of the base stations.

In some RANs, several base stations may be connected, e.g. by landlines or microwave, to a radio network controller, e.g. a Radio Network Controller (RNC) in Universal Mobile Telecommunications System (UMTS), and/or to each other. The radio network controller, also sometimes termed a Base Station Controller (BSC) e.g. in GSM, may supervise and coordinate various activities of the plural base stations connected thereto. GSM is an abbreviation for Global System for Mobile Communications (originally: Groupe Spécial Mobile).

In 3rd Generation Partnership Project (3GPP) Long Term Evolution (LTE), base stations, which may be referred to as eNodeBs or eNBs, may be directly connected to one or more core networks.

UMTS is a third generation mobile communication system, which evolved from the GSM, and is intended to provide improved mobile communication services based on Wideband Code Division Multiple Access (WCDMA) access technology. UMTS Terrestrial Radio Access Network (UTRAN) is essentially a radio access network using wideband code division multiple access for wireless devices. The 3GPP has undertaken to evolve further the UTRAN and GSM based radio access network technologies, for example into evolved UTRAN (E-UTRAN) used in LTE.

In the context of this disclosure, the expression downlink (DL) is used for the transmission path from the base station to the wireless device. The expression uplink (UL) is used for the transmission path in the opposite direction i.e. from the wireless device to the base station.

In a cellular communications network various services are provided, via base stations to wireless devices being served in the cells thereof, such as voice communication services and data services available on or via the Internet, or other local data networks. The data services may be services available on the World Wide Web (WWW), typically accessible to a wireless device via a web browser application installed thereon, or data services that are available via other protocols and/or relevant only to more specific applications or software installed on the wireless device. Using such data services involves download of digital content to the wireless device. Certain parts of the cellular communications network are responsible for identifying wireless devices that request such data services and then makes sure that the service is provided to these wireless devices via respective serving base station. This is preferably provided in such way that the user of the wireless device does not experience any negative impact from the fact that the service is provided via the cellular communications network. For example, a user that uses an application executing on a wireless device, e.g. a web browser, for accessing digital content on the Internet, simply wants the access without having to care of, or be negatively affected, by the fact that the connection is via the cellular communications network.

However, there are certain problems associated with the desire to provide such user experience. One problem is the fact the there is a limited bandwidth in each cell and thereby restrictions in how many wireless devices that may be guaranteed a certain quality of service at the same time. By a continuously increasing number of wireless devices and increasing usage of data services in cellular communications networks of today, the problem is becoming increasingly greater. Even if the overall capacity is increased there will still be a certain maximal amount of bandwidth available in each cell for the delivery of digital content for the data services, and there may be usage peaks where it would be desirable to provide digital content to wireless devices in a cell at such amount and rate that would exceed the capacity of the cell. When this happens the result is a poor user experience, e.g. bad performance of the data service, errors in the digital content and/or data service, or even non-access to the requested digital content or non-availability of the data service.

### SUMMARY

An object of embodiments herein is to provide a way of improving the performance in a cellular communications network.

According to a first aspect of embodiments herein, the object is achieved by a method in a communication node for providing a digital content to at least one wireless device in a cellular communications network. The communication node obtains information identifying the digital content. The digital content is associated with a moving demand area that is an area that changes location over time according to a movement pattern and in which area a demand for the digital content has been identified to move with the area. The communication node further provides, based on the obtained information, a broadcast or multicast of the digital content in a provision area comprising the moving demand area. The provision area corresponds to one or more cells served by one or more base stations broadcasting or multicasting the digital content. The provided broadcast or multicast is adapted based on the movement pattern to thereby enable the at least one wireless device, when located in and moving with the moving demand area, to receive the digital content by the broadcast or multicast.

According to a second aspect of embodiments herein, the object is achieved by a communication node for providing a digital content to at least one wireless device in a cellular communications network. The communication node comprises an obtaining circuitry, configured to obtain information identifying the digital content. The digital content is associated with a moving demand area being an area that changes location over time according to a movement pattern and in which area a demand for the digital content has been identified to move with the area. The communication node further comprises a providing circuitry, configured to, based on the obtained information, provide a broadcast or multicast of the digital content in a provision area comprising the moving demand area. The provision area corresponds to one or more cells served by one or more base stations broadcasting or multicasting the digital content. The provided broadcast or multicast is adapted based on the movement pattern to thereby enable the at least one wireless device, when located in and moving with the moving demand area, to receive the digital content by the broadcast or multicast.

As should be realized, by providing broadcast or multicast of a digital content instead of providing unicast of the digital content, it is enabled sending and addressing of one and the same copy of the digital content to the at least one wireless device, i.e. multiple wireless devices, at the same time. This instead of sending and addressing a separate copy of the digital content to each one of the multiple wireless devices as in the case of unicast that is conventionally used by base stations for delivery of digital content to wireless devices in cellular communications networks. Thus multiple unicast downlink transmissions, one for each one of the multiple wireless devices, where each unicast transmission requires a certain bandwidth, are possible to replace by the provided broadcast or multicast with a bandwidth that is independent on the number of receiving wireless devices.

Hence, by provision of the digital content by the broadcast or multicast in the provision area comprising the moving demand area, and adapted based on the movement pattern, it is enabled efficient delivery of the digital content to the at least one wireless device when located in and moving with the demand area, without the need of allocating any substantial bandwidth for the broadcast or multicast at locations along the movement pattern when the demand area is not located there. This is of particularly interest in order to be able to efficiently serve concentrations, or groups, of wireless devices, e.g. located on a moving train or moving along a road. Such groups or concentrations often cause temporal but potentially very high load on serving cells that often have relatively low capacity to deal with this since it is not economically motivated to employ high capacity cells or guarantee certain available capacity, especially when this is only needed temporarily during short time periods interleaved by much longer timer periods with no or much lower usage of the cell capacity. An advantage with embodiments herein is thus offering of a solution to this problem.

Further advantages for example include:

Wireless devices receiving digital content by broadcast or multicast instead of by unicast enable reduced signaling and less resources may need to be allocated. For example, in LTE, less resource blocks, which may be a limited resource, may need to be allocated.

### BRIEF DESCRIPTION OF THE DRAWINGS

Examples of embodiments herein are described in more detail with reference to the appended schematic drawings, in which:

FIG. 1 is a schematic block diagram depicting an example of a cellular communications network.

FIG. 2 is a schematic block diagram depicting another view of the example in FIG. 1.

FIG. 3 is a schematic block diagram depicting a simplified example of the cellular communications network in which a provision area according to a first example of embodiments herein adapts to a moving demand area.

FIG. 4 is a schematic block diagram depicting a simplified example of the cellular communications network in which a provision area according to a second example of embodiments herein adapts to the moving demand area.

FIG. 5 is a combined signalling diagram and flowchart for illustrating examples of embodiments herein.

FIG. 6 is a flow chart illustrating a method in a communication node according to embodiments herein.

FIG. 7 is a schematic block diagram illustrating a communication node according to embodiments herein.

### DESCRIPTION

Multimedia Broadcast Multicast Services (MBMS) is a point-to-multipoint interface specification for existing and upcoming 3GPP cellular networks, which is designed to provide efficient delivery of broadcast and multicast services. See for example:

ETSI TS 123 246 V9.6.0 (2012-01): Universal Mobile Telecommunications System (UMTS); LTE; Multimedia Broadcast/Multicast Service (MBMS); Architecture and functional description (3GPP TS 23.246 version 9.6.0 Release 9),

ETSI TS 125 346 V9.1.0 (2010-04): Universal Mobile Telecommunications System (UMTS); Introduction of the Multimedia Broadcast/Multicast Service (MBMS) in the Radio Access Network (RAN); Stage 2 (3GPP TS 25.346 version 9.1.0 Release 9), and

ETSI TS 136 300 V9.9.0 (2012-01): LTE; Evolved Universal Terrestrial Radio Access (E-UTRA) and Evolved Universal Terrestrial Radio Access Network (E-UTRAN); Overall description; Stage 2 (3GPP TS 36.300 version 9.9.0 Release 9), Section 15 MBMS.

MBMS for LTE may generally be referred to as evolved MBMS (eMBMS). The embodiments herein are compatible with and may preferably be implemented in a cellular communications network, in particular LTE-based, that support MBMS, i.e. eMBMS. This should be appreciated by the skilled person from the examples that will follow.

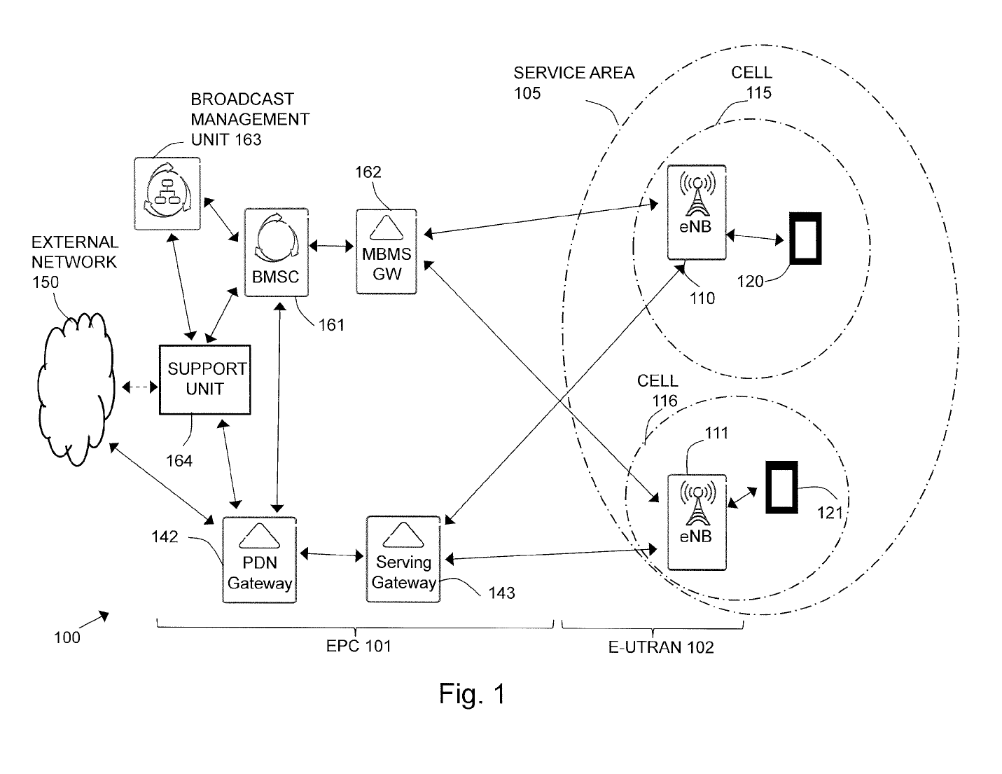

FIG. 1 is a schematic block diagram depicting an example of a cellular communications network 100. In the shown example the cellular communications network 100 corresponds to an LTE based cellular communications network, as should be recognized by the skilled person. As indicated in the figure, the network 100 comprises an Evolved Packet Core (EPC) network 101, being example of a core network, and an Evolved UMTS Terrestrial Radio Access Network (E-UTRAN) 102, being example of a RAN.

The shown cellular communications network 100 further comprises a base station 110 serving a cell 115 and a base station 111 serving a cell 116. The base stations 110, 111 are named eNB in the figure, which is the common denomination used for a base station in LTE-based networks.

Located and served in cell 115 is a first wireless device 120 and located and served in cell 116 is a second wireless device 121. The enumerated naming is only for exemplary reasons. Both the cell 115 and the cell 116 are located in a service area 105. The service area 105 may be defined by the cells that it comprises or may defined by a geographical area and thereby will comprise cells in the same geographical area. The service area 105 will be further discussed below.

The shown arrows in FIG. 1 indicate paths for communication of user plane data, such as communication of digital content that may result when the wireless devices 120, 121 are utilizing data services provided in the cellular communications network 100 for accessing one or more digital contents.

By a digital content is herein meant a digital content that is provided by one or more services available to wireless devices, e.g. the first wireless device 120, in the cellular communications network 100. The digital content may corresponds to such digital content available on the Internet, e.g. available on the World Wide Web (WWW), often referred to as web content, but may also be other kind of digital content. For example, the digital content may relate to a web radio transmission for reception by an application running on the wireless device, a video clip for view on the wireless device, a web-page for execution and display using a web-browser executing on the wireless device, and/or the digital content may be application specific digital content, just to mention some examples. The digital content may correspond to a single data file or a group of data files. The digital content may be live and/or streamed digital content.

Still referring to FIG. 1, the cellular communications network 100 further comprises a Packet Data Network (PDN) Gateway 142 and a Serving Gateway 143, as known from LTE. The PDN Gateway 142 is an example of an interface between an internal IP network of the operator of the cellular communications network 100 and an external network 150. The external network 150 may e.g. be the Internet or a Local Area network (LAN). In LTE, the Serving Gateway 143 has a main task of tunnelling user plane data between the PDN Gateway 142 and the base stations 110, 111. The PDN Gateway 142 and the Serving Gateway 143 are logical units in LTE, which logical units may be implemented in the same physical unit, but more typically in separate physical units and as separate network nodes in the cellular communications network 100, in particular in the EPC network 101 thereof.

The shown cellular communications network 100 also comprises a MBMS GateWay (MBMS GW) 162 and a Broadcast Multicast Service Center (BMSC) 161. The general role, task and interrelations of the MBMS GW 162 and a BMSC 161 may be in accordance with the above mentioned 3GPP specifications relating to MBMS for LTE, i.e eMBMS. Hence, the MBMS GW 162 may i.a. provide functionality for sending of MBMS packets comprising the digital content to the base stations 110, 111 for broadcast or multicast in the cells 115, 116. The MBMS GW 162 may use IP multicast as a means for forwarding MBMS user plane data, such as the digital content in the MBMS packets, to the base stations 110, 111. Note that this may be the case even though the digital content is being provided by broadcast in the respective cells. The BMSC 161 may i.a. be responsible for delivering user plane data, such as the digital content, to the MBMS GW 162. The BMSC 161 may also provide a number of service layer function such as Forward Error Correction (FEC) and file repair in order to ensure Quality of Service (QoS) in delivery of the digital content to the wireless devices 120, 121. Also, service announcements of what is available by broadcast or multicast to the wireless devices 120, 121, may be provided as a service layer function by the BMSC 161.

The shown cellular communications network 100 also comprises a broadcast management unit 163 for providing the digital content to the wireless devices 120, 121, by e.g. controlling the BMSC 161, directly, via and/or with support from one or more support units that will be further discussed below. The broadcast management unit 163 may e.g. be involved in and/or responsible for deciding what digital content to provide and when and where it shall be provided for the broadcast or multicast. Or in other words, the broadcast management unit 163 may be involved in and/or responsible for providing, planning and scheduling the provision the digital content for the broadcast or multicast. The broadcast management unit 163 may also be involved in and/or responsible for monitoring tasks, archiving tasks, and/or provide support to various organizations, typically within or connected to the operators of the cellular communications network 100, such as to network operations, service operations, customer care and also co-operating organizations, e.g. service providers of digital content. The broadcast management unit 163 will be further discussed below. The MBMS GW 162 and the BMSC 161 are logical units, which may be implemented in a respective corresponding physical unit or units, or together with other logical units or functionality in one or more shared physical units. Furthermore, the MBMS GW 162 and the BMSC 161 typically represent separate network nodes in the cellular communications network 100, more particularly in the EPC network 101 thereof. The broadcast management unit 163 is a logical unit that may be implemented in a corresponding physical unit or units, or together with other logical units or functionality in one or more shared physical units. The broadcast management unit 163 may correspond to a network node in the cellular communications network 100, such as in the EPC 163 in case of an LTE based cellular communications network 100.

As illustrated in FIG. 1, the cellular communications network 100 may further comprise one or more support units 164 that may be communicatively connected to the BMSC 161, the broadcast management unit 163 and/or to each other. The one or more support units 164 may e.g. comprise a content providing unit, a data carousel providing unit, a scheduling unit, traffic analyzing unit and/or a position identifying unit.

The content providing unit may e.g. provide digital content from one or more sources to the BMSC 161 and/or to the data carousel providing unit. Digital content and examples thereof are discussed in some detail below. One source may be the external network 150, e.g. the Internet, from which the digital content may be retrieved via the PDN Gateway 142 or via some other connection. Another source may be digital content provided by e.g. a producer of the digital content exclusively for the broadcast or multicast. Yet another source may be one or more encoders or re-encoders for content that is relevant to transform before being subject to broadcast or multicast, e.g. analogue content and/or content in an inappropriate digital format. For example, digital content produced for another kind of system, e.g. television, such as video content from television satellites may be inappropriate to use directly in a network based on LTE and eMBMS. The content providing unit may further comprise and/or be configured to retrieve digital content from one or more storages in the cellular communications network 100, typically in the EPC network 101. The one or more storages may be comprised in the content providing unit. Some or all of the one or more storages may be in a physical unit that corresponds to the content providing unit, and/or some or all of the one or more storages may be in one or more physical units that are separate from a physical unit comprising the content providing unit. Digital content that has been stored in and is available from the one or more storages in the cellular communications network 100 enable a faster response to a decision to provide the digital content by broadcast or multicast and may also guarantee availability and quality of the digital content to be used for the broadcast or multicast. In some embodiments, one or more such storages may be connected to the PDN Gateway 142 and the BMSC 161 and be configured, e.g. via the PDN Gateway 142, to store digital content that is a candidate to be provided by the broadcast or multicast. The broadcast management unit 163 may be responsible for configuring what and when to store something in the one or more storages.

Still referring to FIG. 1 and the one or more support units 164. The scheduling unit that may be comprised in the one or more support units 164 may e.g. provide information about when to start and/or stop and/or change the broadcast or multicast, e.g. when to add or remove the digital content from the broadcast or multicast. Scheduling of digital content is further discussed below.

The data carousel providing unit that may be comprised in the one or more support units 164 may e.g. provide a data carousel where digital content that has been retrieved for the broadcast or multicast is inserted. By broadcast of the data carousel, the digital content will repeatedly occur in the broadcast or multicast. As should be understood, a data carousel is mainly relevant for digital content corresponding to data files but typically not for streaming data. For example, by providing a file of digital content in a data carousel, the file of digital content is made more suitable for continuous broadcast or multicast and to be provided by broadcast or multicast at the same time together with other digital content. The other digital content may be comprised in the same or another data carousel, or may be such that is already provided as a data stream, e.g. a web radio transmission. The scheduling unit may operate directly on the data carousel providing unit so that a data carousel comprising properly scheduled digital content may be provided to the BMSC 161. By digital content comprised in a data carousel may be referred to data format and/or structure where one or more copies of the digital content may be interleaved with other data and where the format and/or structure is for sending in a repeating pattern. Sending of the data carousel may thus result in repeated sending of the digital content, corresponding to a data stream where copies of the digital content repeatedly will occur.

The traffic analyzing unit that may be comprised in the one or more support units 164 may e.g. be arranged to monitor traffic relating to digital content and that is associated with an area, e.g. the service area 105, where broadcast or multicast is or may be provided and/or traffic associated with certain wireless devices. For performing its task the traffic analyzing unit may e.g. be arranged to receive traffic information directly or indirectly from the PDN Gateway 142, the Serving Gateway 142 and/or the base stations 120, 121.

The position identifying unit that may be comprised in the one or more support units 164 may e.g. be arranged to identify position of an object, e.g. wireless device 120, associated with the broadcast or multicast. For identifying the position, the position identifying unit may e.g. be arranged to receive information directly or indirectly from the base stations 120, 121, the wireless devices 120, 121, the broadcast management unit 163 and/or the BMSC 161. The position identifying unit may e.g. be arranged to send information about an identified position to the broadcast management unit 163 and/or the traffic analyzing unit.

In some embodiments, one or more support units 164 may be a respective logical unit that may be implemented in one and the same physical unit as e.g. the BMSC 161 or the broadcast management unit 163. In some embodiments, one or more support units 164 may be a respective logical unit that corresponds to a separate physical unit. How the one or more support units 164 may be used in context of embodiments herein will be further discussed below.

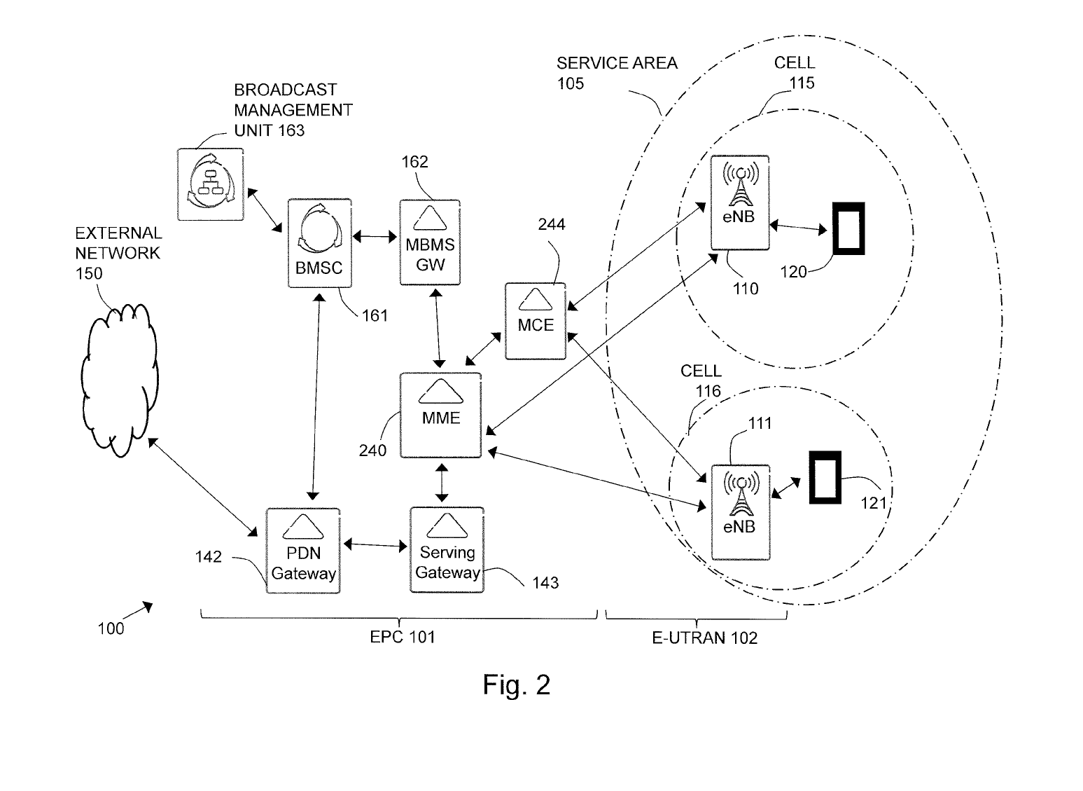

FIG. 2 is a schematic block diagram depicting another view of the example in FIG. 1, here regarding session control signalling, instead of communication of user plane data as in FIG. 1. The two different view are for reducing complexity in each view for readability reasons. The difference between session control signalling and communication of user plane data, should be well known to the person skilled in cellular communications networks, in particular LTE. For example, session control signalling typically involve setting up and configuring data bearers that are used for the communication of user plane data. Hence, the cellular communications network 100 may also comprise a Mobility Management Entity (MME) 240, known from e.g. LTE, that communicates with the eNBs, here base stations 110 and 111, and the Serving Gateway 143. The MME 240 may be regarded as main responsible for the session control signalling and setting up and configuring of data bearers for user plane traffic to and from the wireless devices 120-121. This is also the case for MBMS related traffic for LTE, but where the MME 240, as shown, communicates with the MBMS GW 162 instead of the Serving Gateway 143. In case of data bearers that are MBMS related, the MME 240 may not communicate directly with the eNBs, here base stations 110, 111, but via a Multi-cell/multicast Coordination Entity (MCE) 244, as shown in FIG. 2. The MME 240 is a logical unit, which may be implemented in a corresponding physical unit, or together with other logical units or functionality in one or more shared physical units. The MME 240 is a network node in the cellular communications network 100, or more particularly, as shown, in the EPC network 101 thereof. The MCE 244 is also a logical unit, which may be implemented in a corresponding physical unit, or together with other logical units or functionality in one or more shared physical units. For example, there may be one MME 244 that corresponds to a physical unit communicatively connected to several base stations, such as with base stations 110, 111, as shown in FIG. 2, or there may be several MMEs, a respective one for and integrated with each base station.

Session control signaling for embodiments herein when implemented in an LTE and eMBMS based cellular communications network 100, as shown in FIG. 1 and FIG. 2, may follow normal procedures and will therefore not be discussed in any further detail in the following. For example, how the BMSC 161 has been configured and what digital content to broadcast or multicast, does not affect the procedures for the session control signaling as such. The skilled person with knowledge of LTE and eMBMS will realize what session control signaling will be involved and may be needed for implementation of embodiments herein.

When the digital content is provided by broadcast or multicast instead of unicast, the result is that one and the same copy of the digital content may be received by multiple wireless devices at the same time, instead of sending and addressing a separate copy of the digital content to each one of multiple wireless devices, e.g. each one of the wireless devices 120-121, as in the case of unicast. Hence multiple unicast downlink transmissions, e.g. one for each one of individual wireless devices, where each unicast transmission would require a certain bandwidth, are possible to replace by broadcast or multicast with a bandwidth that is independent on the number of receiving wireless devices. This may be used to reduce the risk of capacity overload in the cell or cells subject to the broadcast or multicast. However, this does not happen automatically just because e.g. an LTE based cellular communications network is supporting eMBMS. There should e.g. be services available to users and that should be attractive enough to be used. Moreover, there is a freedom of choice in what digital content that is to be subject for broadcast or multicast and where to provide the broadcast or multicast. Another issue is how to get a wireless device to receive and utilize the digital content. This will be dealt with in the following, in context of embodiments herein.

However, first it is again reminded that FIG. 1 and FIG. 2 are only schematic and for exemplifying purpose. The cellular communications network 100 may in reality comprise several further cells, base stations, wireless devices, and other network nodes, including management entities, which are not shown herein. Hence, the situation shown in FIG. 1 and FIG. 2 and discussed above, is not in every detail a prerequisite for embodiments herein, as should be understood by the skilled person, and in particular when considering the present application as a whole. For example, FIG. 1 only shows one service area, while embodiments herein are relevant also when the cellular communications network 100 comprises several service areas, or corresponding area where broadcast or multicast of digital content is provided. There may for example be a service area for each population dense area, such as city area, with an expected or known high utilization degree of the capacity provided by the cells of the cellular communications network 100 in that area. Also, in FIG. 1 and FIG. 2 it is only shown two cells 115, 116 in the shown service area 105, however, in some embodiments there may be one or more service areas comprising only a single cell, i.e. the service area 105 may correspond to a single cell, although a more typical situation is that the service area 105 comprises say at least ten, hundreds or even thousand cells, for example every cell in a large city.

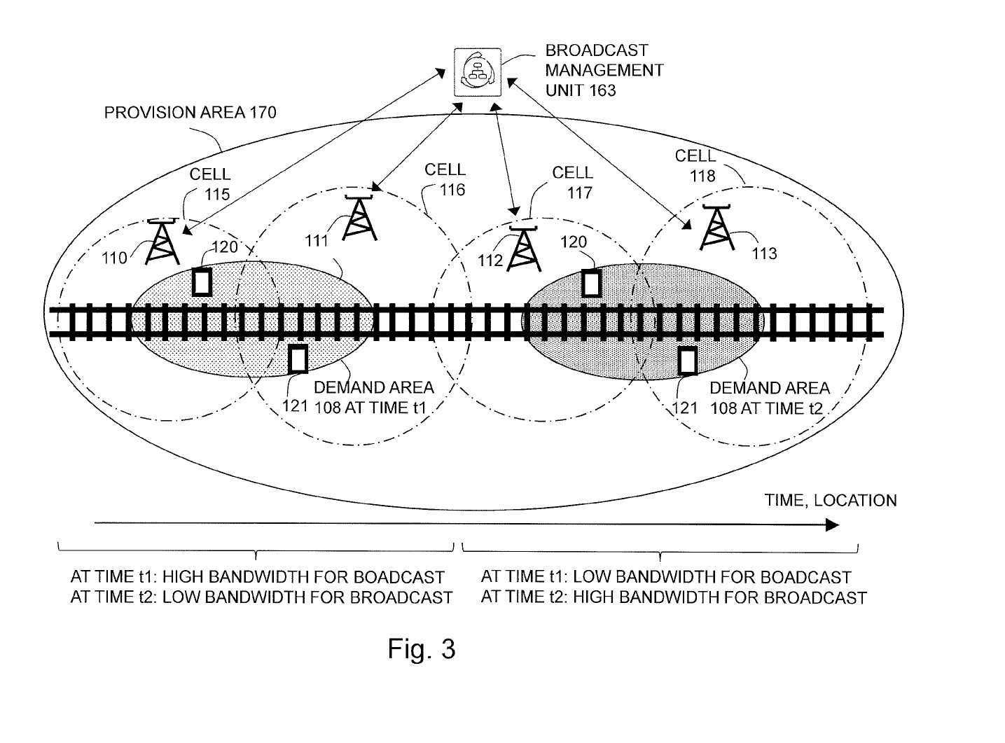

FIG. 3 is a schematic block diagram depicting another partly simplified example of the cellular communications network 100 in which a provision area 170 is shown to comprise and adapt to a moving demand area 108 in accordance with a first type of embodiments herein. The moving demand area 108 is an area that changes location over time according to a movement pattern, in which area a demand for a digital content has been identified to move with the area. The moving demand area 108 and movement pattern is typically associated with a known movement of a concentration, or group, of wireless devices, e.g. located on a moving train or in cars, thus moving along a railway, or moving along a road. A symbolic railway is depicted in FIG. 3 to facilitate visualization. The moving demand area 108 and movement pattern are further explained below. As also will be further discussed below, the broadcast management unit 163 provides, here via the base stations 110-118 serving cells 115-117 of the cellular communications network 100, a broadcast or multicast of the digital content in the provision area 170 comprising the moving demand area 108 and the cells 115-118. The example of FIG. 3 is simplified e.g. in that only the broadcast manager 163 is shown among many of the other units and features shown and discussed in connection with FIG. 1-2 above. However, as should be realized, the communication between the broadcast manager 163 and the base stations is in practice typically indirect and e.g. via the BMSC etc. as discussed in connection with FIG. 1-2 above, although not limited to this, as already mentioned. The broadcast manager 163 or corresponding entity may thus provide the broadcast or multicast in the provision area 170 through direct or indirect communication that involves other means than exemplified herein.

The wireless devices 120, 121 depicted in FIG. 3 may e.g. be located on a train covering a ground area that corresponds to the moving demand area 108 and that is moving according to the movement pattern. The provided broadcast or multicast in the provision area 170 is adapted based on the movement pattern so that the wireless devices 120, 121 are enabled to receive the digital content in the moving demand area 108 when it moves according to the movement pattern. In the figure, the location of the moving demand area 108 is shown at two exemplifying instances in time, at a time instance t1 and at a time instance t2. At the first time instance t1, the moving demand area 108 is covered by cells 115, 116, but not cells 117, 118, of the provision area 170, and at time instance t2, the demand area 108 has moved some distance according to the movement pattern and is no longer covered by the cells 115, 116 but instead by the cells 117, 118. Said adaptation of the provision area 170 to the demand area 108 for the first type of embodiments illustrated in FIG. 3 involves changing bandwidth allocated for the provided broadcast or multicast in the cells 115-118 of the provision area 170, so that there is higher allocated bandwidth for a cell thereof when it is at least partly covered by the demand area 108 and lower allocated bandwidth for a cell thereof when it is not covered by the demand area 108. For example, at the time instance t1 it is higher allocated bandwidth for the broadcast or multicast in cells 115, 116 and lower, e.g. no or substantially no, bandwidth allocated for the broadcast or multicast in cells 117, 118. At the time instance t2 the situation is the opposite. What exact bandwidth to allocate, absolute or relative, for the higher and/or lower bandwidths, may be predetermined and/or take into account the total available bandwidth and prioritized traffic in each cell involved, the type of identified demand, discussed below, the number of wireless devices, in the moving demand area 108, which may be relevant for receiving the broadcast or multicast etc. For example it is greater incentive to allocate higher bandwidth and thereby provide a greater user experience if there are many wireless devices relevant for receiving the broadcast or multicast in the moving demand area 108. One advantage with the first type of embodiments is e.g. that the provision area 170 may correspond more or less directly to the type of service area, exemplified by service area 105, discussed in the foregoing, which may be set up to cover relevant transport infrastructure and without the need of changing the provision area 170 when the moving demand area 108 moves according to the movement pattern. This may facilitate compatibility with and implementation in a system, e.g. of the type discussed in the foregoing, that simultaneously may support also other usages of broadcast or multicast in the cellular communications system 100. To accomplish the adaptation of the provision area 107, updated configurations with updated bandwidth settings for the broadcast or multicast in the cells 115-118 of the provision area 170 may e.g. be sent to the BMSC 161 based on the movement pattern.

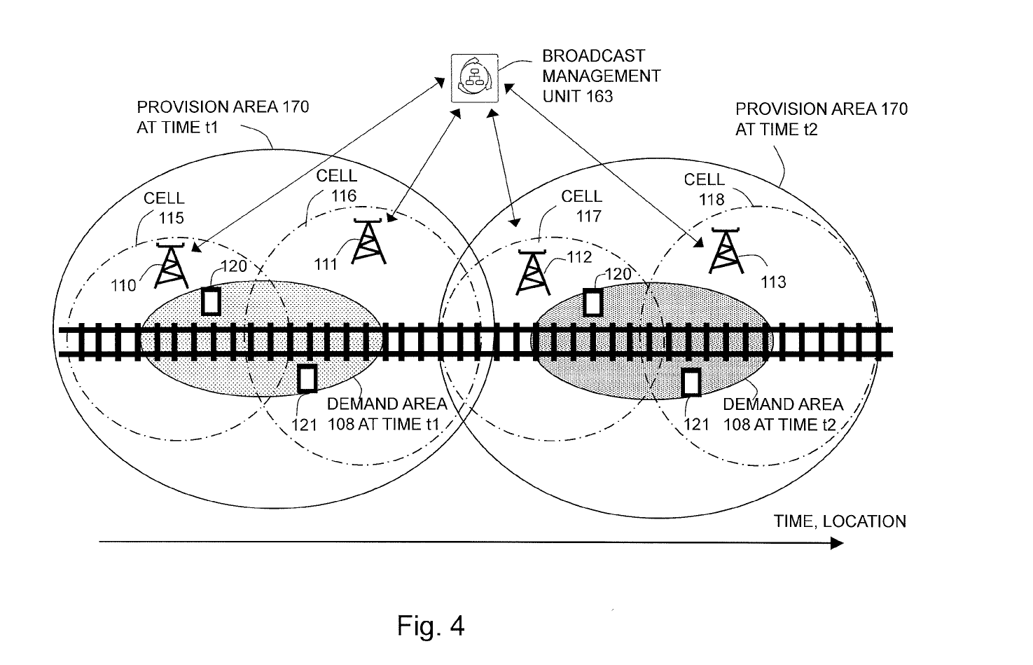

FIG. 4 is a schematic block diagram depicting yet another partly simplified example of the cellular communications network 100 in which the provision area 170 is shown comprising and adapting to the moving demand area 108 in accordance with a second type of embodiments herein. Similarities between the first and second type of embodiments are evident from comparison of FIG. 3 and FIG. 4 and focus here will therefore be on the differences. The adaptation of the provision area 170 here involves adding new cells to and removing cells from one or more cells 115-118 that correspond to, e.g. by forming, the provision area 170 so that the provision area 170 thereby moves with the moving demand area 108. For example, at time instance t1, the provision area 170 comprises cells 115, 116 but not cells 117, 118, and at time instance t2, cells 115, 116 have been removed and instead cells 117, 118, corresponds to the provision area 170. In contrast to the first type of embodiments, the provision area 170 here changes when the demand area 108 moves. In case of provision of the broadcast or multicast in the type of service area, discussed in the foregoing and exemplified by service area 105, there may e.g. be several such service areas predefined along the way, e.g. infrastructure, where the demand area 108 will move according to the movement pattern. Each of these service areas may comprise one or more cells so the moving demand area 108 is able to be completely covered by each service area. The broadcast or multicast in these service areas is then switched on and off based on the movement pattern so that the desired provision area 170, which may be implicitly defined by the service area/s or cell/s having the broadcast or multicast switched on based on the movement pattern, is accomplished. For example, if there are service areas A, B and C along the way, sequentially occurring adjacent to each other, each service area able to completely cover moving demand area 108 at some time instance during movement according to the movement pattern. A sequence of service areas with broadcast or multicast switched on may then be: A:A&B:B:B&C:C, or A&B:B&C or any other suitable sequence of service areas. It may also be possible to utilize a dynamic service area that is identified as one and the same service area, but where the cells comprised in the service area may change over time, i.e. a service area that changes over time. Such dynamic service area could be configured to essentially correspond to the provision area 170 according to the second type of embodiment and may facilitate configuring such provision area and adaptation of the broadcast or multicast.

Both in case of the first and second type of embodiments, adaptation of the broadcast or multicast in the provision area 170 may e.g. be implemented by sending of updated configurations to the BMSC 161 discussed in the foregoing, taking into account an initial moving demand area and/or movement pattern followed by e.g. later updated configurations, or information therein, based on updated timing information, e.g. updated train table, location information regarding actual location at certain points in time, or delay information. The timing information may originate from observations of a present situation, i.e. by studying and comparing movement of some of the wireless devices, e.g. the wireless devices 120, 121, identified to be located in the moving demand area 108 and how they move by utilizing positioning services available in the cellular communications network. An identified deviation from what would be expected based on a movement pattern presently being applied may be used to update and improve the movement pattern.

The moving demand area 108 and the movement pattern will now be further discussed and exemplified. As already discussed to some extent, the movement pattern may initially be set according to a predefined timing information, such as a time schedule, e.g. a train time table or known commuter schedules, and then be updated based on more recent and potentially more accurate information, such as the updated timing information discussed above. That is, the broadcast or multicast in the provision area 170 may be pre-scheduled according to an initial demand area and movement pattern and may then be adapted based on information about a present situation, i.e. live or nearly live information. The movement pattern may be fully or partly based on location measurements of one or more wireless devices identified to move with the demand area. For example, wireless devices that are known to be located on a train at some point in time, such as wireless devices 120, 121 shown in FIGS. 3-4, or a group or concentration of wireless devices identified to move along a road. It is also possible to use a dedicated positioning device arranged to move with the moving demand area 108.

In case of wireless devices associated with passengers on a train, the moving demand area 108 may be predefined to cover the area occupied by the train and to move according to an initial time schedule of the train. This may provide an initial movement pattern, and the broadcast or multicast be pre-scheduled accordingly. One likely type of digital content there may be a demand for in this situation is e.g. web sites or application specific data associated with updated time schedule or other information associated with the train and/or the travel.

In case of wireless devices associated with car commuters there is typically along a road during certain hours a high concentration of cars and thus wireless devices that may be expected to be distributed according to some statistical distribution, e.g. a standard distribution with a peak area covering a greatest concentration and which peak area move along the road, i.e. according a movement pattern. The moving demand area 108 may correspond to such peak area. Note that in this case it will not be the same wireless devices in the peak area all the time, it is even possible that none of the wireless devices located in the peak area at the start according to the movement pattern are in the peak area at the end according to the movement pattern. In any case, it is realized that such distribution, peak area and movement pattern may be identified by e.g. analyzing wireless device traffic from cells covering roads known to be used by commuters. This may provide at least an initial demand area and movement pattern and the broadcast or multicast be pre-scheduled accordingly. One likely type of digital content there may be a demand for in this situation is e.g. web radio transmissions and/or traffic related content, such as navigation related information.

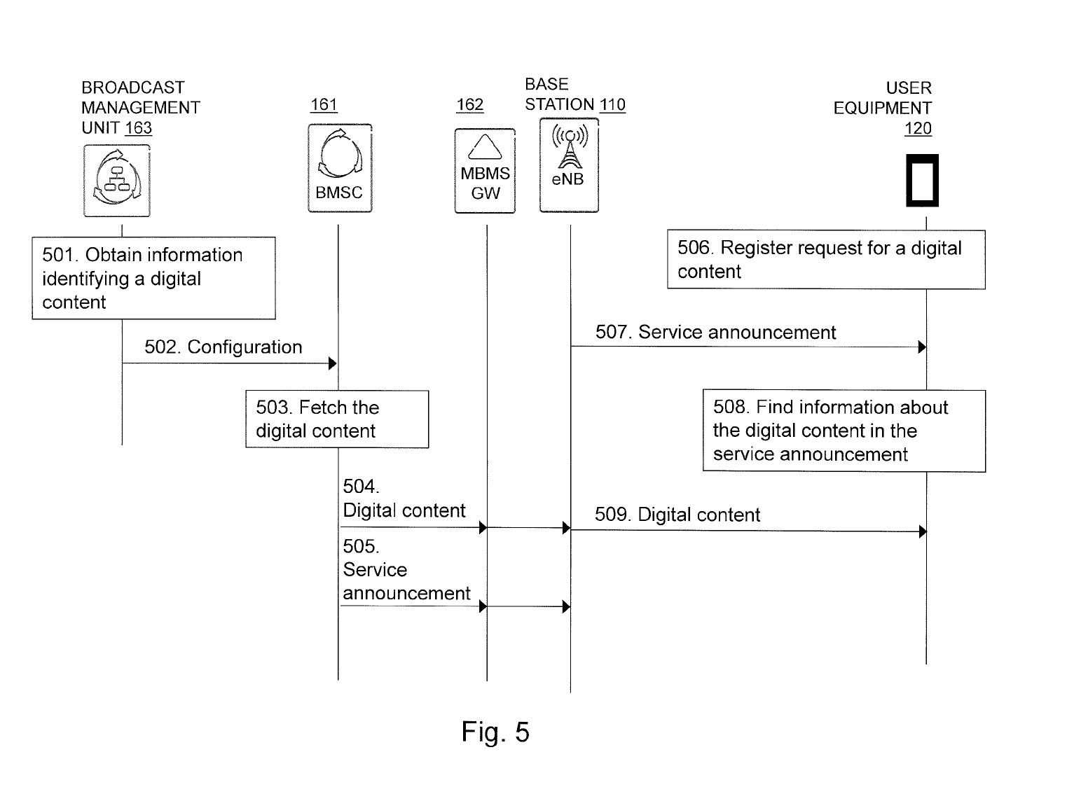

Examples of embodiments herein relating to a method in the broadcast management unit 163 for providing a digital content to at least one wireless device, such as wireless device 120, in the cellular communications network 100, will now be described with reference to the combined signaling diagram and flowchart depicted in FIG. 5. The actions may be taken in any suitable order.

Action 501

The broadcast management unit 163 obtains information identifying the digital content. The digital content is associated with the moving demand area 108, i.e. an area that change location over time according to a movement pattern and in which area a demand for the digital content has been identified to move with the area. The demand and how to find suitable digital content is discussed separately below.

The obtained information may e.g. comprise a copy of the digital content as such or a link or network path to where it is available.

The obtained information may also explicitly or implicitly identify the moving demand area 108, the provision area 170 and/or the movement pattern. Implicitly e.g. through some tagging of the digital content. The moving demand area 108, the provision area 107 and/or movement pattern may be predefined or predetermined and associated with the tagging. The tagging may be explicit or implicit. Implicit for example if all digital content from a certain source is known to be associated with a certain moving demand area 108, provision area 170 and/or the movement pattern.

For example, in case of the first type of embodiments, all digital information from a source “for train xxx between Stockholm-Gothenburg” may be predetermined to be broadcasted in a provision area predetermined to be formed by cells covering the railway between Stockholm and Gothenburg with bandwidths for the broadcast in this cells that are pre-scheduled based on the time table for the train and are subject to adjustments based on updated timing information, e.g. information on delays.

Action 502

The broadcast management unit 163 sends, in response to the decision in Action 501, a configuration e.g. to the BMSC 161 in order to provide the broadcast or multicast of the digital content in the provision area 170 comprising the moving demand area 108.

As discussed in the foregoing the broadcast or multicast is to be provided adaptively based on the movement pattern, thereby enabling the wireless devices 120, 122, when located in and moving with the moving demand area 108, e.g. by being located on and moving with a train, to receive the digital content by the broadcast or multicast. As understood from the discussion above in connection with FIGS. 3-4, adaptation of the provided broadcast or multicast may be carried out in more than one way, which in turn may affect what may be comprised in the configuration. Some examples will still be given, the configuration may e.g. comprise one or more of the following: An identifier of the digital content so that the BMSC 161 is able to fetch and use the digital content for the broadcast or multicast. An identifier of the cell or cells, e.g. the cells 115-118, where the broadcast or multicast is to be provided. A bandwidth and/or bandwidths to be used for the broadcast or multicast in respective cell. Information about when to start and/or when to stop the broadcast or multicast of the digital content and or change bandwidth. Information to be comprised in the service announcement (see e.g. Action 405 below).

Note, as mentioned previously, that in some embodiments, the configuration wholly or partly may be sent via one or more support units 164. As should be understood from the discussion above in connection with FIG. 3-4, the provision area 170 may be identified by one or more service areas or one or more cells. Information available for identifying the provision area 170 and/or the movement pattern may be directly used for inclusion in the configuration or it may be processed first. For example, an initial moving demand area and movement pattern may be defined using geographical coordinates and timing information, and be input to and used by the broadcast manager 163, or one or more support units 163, such as the scheduling unit, to determine identities of cells relevant for the provision area 170 and/or a determine schedule regarding the adaptation of the broadcast or multicast in the provision area 170. The resulting information may then be used for configuring the BMSC 161. There may be a first configuration sent that is based on an initial moving demand area and/or movement pattern associated with the digital content, then there may be related further configurations sent to accomplish the adaptation according to the movement pattern and possibly also taking into account the above-mentioned later updates based on updated information, such as updated train table or delay information.

The identifier of the digital content may refer to digital content provided from the one or more support units 164 discussed above, e.g. the content providing unit or the data carousel providing unit, or may be an identifier referring to content available elsewhere, e.g. in the external network 150, such as the Internet. Note that for example, an identifier of service area, e.g. the service area 105, or provision area 170, may be regarded an identifier of the cell or cells comprised therein, e.g. cell 115, when such relation is known.

As mentioned, in some embodiments, support for providing the broadcast or multicast is provided by the one or more support units 164. The BMSC 161 may in turn use the received configuration to configure and/or instruct one or more of the support units to provide the support. In some embodiments, the configuration or other information may be sent by the broadcast management unit 163 to one or more of the support units 164 that may forward it to the BMSC 161 or may use it to further configure and/or instruct the BMSC 161 and/or one or more other support units.

There may be several different configurations and/or instructions sent by the broadcast management unit 163. One or more of said several configurations and/or instructions may be sent to respective one or more support units 164 to make the one or more support units 164 provide the support. For example, sending of the configuration to the BMSC 161 may in some embodiments include that the broadcast management unit 163 sends a configuration to the scheduling unit comprised in the one or more support units 164. The scheduling unit may then, in response, schedule the broadcast or multicast taking into account the provision area 170, movement pattern and possibly said later updates based on updated information and then initiate the broadcast or multicast according to the schedule directly with the BMSC 161 or indirectly, e.g. back via the broadcast management unit 163 or via the data carousel unit also comprised in the one or more support units 164. When the data carousel unit is involved, the data carousel unit may fetch the digital content from or via the content providing unit, also comprised in the one or more support units 164, and may then provide a data carousel comprising the digital content to the BMSC 161 for accomplishing the broadcast or the multicast. The BMSC 161 may fetch the digital content for the broadcast or multicast from, or via, the content providing unit, e.g. such digital content that is not first to be arranged in a data carousel by the data carousel unit.

Action 503

The BMSC 161 fetches, based on the configuration, the digital content for the broadcast or multicast. The BMSC 161 may fetch the digital content from the external network 150, e.g. the Internet, via the PDN Gateway 142, or the digital content may be fetched from within the cellular communications network 100. In some embodiments it is fetched from or via the content providing unit comprised in the one or more support units 164, discussed above. Note that even in a case when the BMSC 161, in response to the received configuration, fetches the digital content from the external network 150 instead from an internal storage of e.g. the content providing unit as discussed above, the fetched digital content may still be stored temporarily in an internal storage, e.g. located in the BMSC 161 or in the data carousel unit as discussed above, until it is time to use the digital content to provide the broadcast or multicast, e.g. by adding the digital content to a data carousel subject to the broadcast or multicast.

Action 504

The BMSC 161 sends, using information in the configuration, the fetched digital content, via the MBMS GW 162, to one or more base stations, such as base stations 110-113, serving the cell or cells relevant for the broadcast or multicast, such as the one or more cells 115-118. In FIG. 4, the relevant baser station/s and cell/s are represented for exemplifying purpose by base station 110 serving cell 115.

The fetched digital content may be sent to respective relevant base station in association with a message commanding the respective relevant base station to broadcast or multicast the digital content and e.g. which cell/s and/or bandwidth/s to use for this. For example, base station 110 may be commanded to broadcast the digital content in cell 110 using a certain bandwidth during a time interval comprising the time instance t1 so that the digital content will be broadcasted using said bandwidth at least as long as the moving demand area 108 covers the cell 110.

In case of the first type of embodiments discussed above in connection with FIG. 3, the digital content and a message comprising information on what bandwidth to use may be sent to base stations 110-113 to accomplish the broadcast or multicast in cells 115-118. When it is time to change bandwidth for the broadcast or multicast in order to accomplish the adaptation of the provision area 170, e.g. between the time instances t1 and t2, a new message comprising information on the new bandwidths to be used may be sent so that the desired bandwidth is accomplished.

In case of the second type of embodiments discussed in connection with FIG. 4, the digital content would be sent to base stations 110, 111 for broadcast or multicast in cells 115, 116 at the time instance t1, and to base stations 112, 113 for broadcast or multicast in cells 117, 118 at the time instance t2. Between the time instances t1 and t2, when the cells 115 and/or 116 are no longer covering the moving demand area, a respective new message may be sent to each one of the base stations 110, 111, commanding them to stop the broadcast or multicast.

In some embodiments a respective bandwidth change schedule may be sent to the respective relevant base station, such as base station 110, or the MBMS GW 162. It is then up to the respective relevant base station or the MBMS GW 162 to make sure the respective relevant base station changes bandwidth and/or switches the broadcast or multicast on/off according to this schedule. If/when the bandwidth change schedule needs to be updated, e.g. in response to received updated information as discussed above, it may be sent new information when to change bandwidth for the broadcast or multicast and/or when to switch it on/off. The new information may be in the form of a new bandwidth change schedule.

Hence, the present action makes the digital content available to wireless devices, such as wireless devices 120, 121, located in the moving demand area 108, e.g. by being located on a train corresponding to the moving demand area 108. The digital content is made available to all wireless devices located in the moving demand area 108, e.g. wireless devices 120-121 (if broadcast) or available to multiple, but not necessarily all (if multicast). In the latter case, the multicast may e.g. include the first wireless device 120 and exclude the second wireless device 121. However, note that availability of digital content to a wireless device does not necessarily mean that that the digital content is relevant to be downloaded and/or be used by the wireless device in question.

The wireless devices 120, 122 are thus, when located in and moving with the moving demand area 108, enabled to receive the digital content by the broadcast or multicast.

Action 505

The BMSC 161 may also send a service announcement, via the MBMS GW 162, to the base stations 110, 111 that receive the service announcement and broadcast or multicast the received service announcement in the respective cell 115, 116.

The service announcement identifies the digital content and the availability of the digital content in the provided broadcast or multicast. The service announcement comprises information to wireless devices, such as the first wireless device 120, about what digital content is available by the broadcast or multicast.

The service announcement may be provided as a service layer function by the BMSC 161. One purpose of the service announcement is to enable overview of the digital content being provided by the broadcast or multicast without having to first receive the actual digital content. The service announcement may thus e.g. enable faster knowledge and evaluation of the available digital content by the wireless devices, e.g. the first wireless device 120.

The service announcement is typically, but not necessarily, comprised in a data carousel, which may be referred to as a service announcement carousel. In some embodiments with a service announcement it may e.g. be received via unicast. In e.g. eMBMS, discussed in the foregoing, the service announcement carousel may repeat sending Metadata Fragments at predetermined intervals, see e.g. ETSI TS 126 346 V9.7.0 (2012-07): Universal Mobile Telecommunications System (UMTS); LTE; Multimedia Broadcast/Multicast Service (MBMS); Protocols and codecs (3GPP TS 26.346 version 9.7.0 Release 9), Section 5.2 User Service Discovery/Announcement.

The service announcement carousel may be provided to the BMSC 161 by the one or more support units 164. The creation and insertion of service announcements in the broadcast or multicast may be arranged to follow automatically based on the digital content that is actually being provided by the broadcast or multicast, which is information that may be present in and taken from e.g. the BMSC 161, the broadcast management unit 163 and/or the one or more support units 164.

Hence, when a service announcement is present, it may suffice that the wireless device 120 is able to receive and read the service announcement to be able to find and download the digital content that is provided by the broadcast or multicast, that is, through the service announcement it is obtained information for finding and identifying the digital content in the provided broadcast or multicast.

The service announcement may be transmitted using an MBMS bearer that is default available to wireless devices being served in a cell where the broadcast or multicast is provided, e.g. to the first wireless device 120. For example, in LTE and eMBMS, information where to find the service announcement may be transmitted in a Multicast Control Channel (MCCH) that is listened to by every wireless device entering a cell where broadcast or multicast is provided.

However, note that in some embodiments there may be no service announcement. Instead the digital content as such may be automatically downloaded by a wireless device, e.g. the first wireless device 120, when available, and checked for relevance. In such embodiments it may be predetermined where in each cell digital content provided by broadcast or multicast is to be found if present.

Action 506

The first wireless device 120 is in actions 506-509 used as an example of an receiving wireless device of the broadcast or multicast provided by the previous actions. The first wireless device 120 registers, within the first wireless device 120, a request for digital content. The request may be result from a user generated action, e.g. user selection in an application, executing on the wireless device 120, of a file to download or audio or video stream to view or listen to. The request being registered may also follow from an automatically triggered event on the wireless device, e.g. at a predetermined point in time or following release of some trigger that e.g. new software is available for download. Such trigger may e.g. be received by unicast through an application, e.g. an application store or application for maintenance of installed applications.

Action 507

The wireless device 120 receives the service announcement from the base station 110, which may be in response to the registered request and/or owing to that the wireless device 120 is configured to always receive and check available service announcements to know what digital content, if any, is available from broadcast or multicast by its serving base station, here exemplified by base station 110. When the wireless device 120 moves within or with the moving demand area 108 and thereby is subject for handover and change of serving base station, the wireless device 120 will thus receive service announcements, and typically also digital content, from different base stations, e.g. base station 112 at the time instance t2 as shown in FIGS. 3-4. It should be understood that the present action may precede and even be independent from Action 506. Purpose, how and where the first wireless device 120 may find the service announcement and information that may be comprised in the service announcement, was discussed also above, see e.g. Action 505.

Action 508

The first wireless device 120 finds, in the received service announcement, information about digital content available from broadcast or multicast by its serving base station, here base station 110. It is here assumed that the digital content requested in Action 506 is found in the service announcement and that it corresponds to the digital content discussed above for Actions 501-505, i.e. is available by the broadcast or multicast in the provision area 170. If the requested digital content is not found in the service announcement, and/or generally, is not available by broadcast or multicast, the wireless device may request and receive the requested digital content in a conventional way by unicast. The information in the received service announcement identifies the digital content and the availability of the digital content in the provided broadcast or multicast, i.e. the information relates to how to find and receive the digital content from the broadcast or multicast provided in the provision area 170 by the base station presently serving the wireless device 120, e.g. base station 110.

Action 509

The first wireless device 120 receives the digital content by the broadcast or multicast from the base station 110 in response to the information about the digital content that was found in the service announcement. In case of the earlier mentioned embodiments where no service announcement is used, it may instead be in response to that the digital content as such was first received and then checked for relevance by e.g. determining that it is the digital content for which the request was registered in action 506.

The demand and thus how suitable digital content for the broadcast or multicast may be found will now be discussed. When the moving demand area 108 starts moving, e.g. the train starts to travel and/or at a time an initial commuter concentration is formed, e.g. when the concentration reaches a certain threshold at an initial location, wireless device traffic and/or user profiles associated with wireless devices located in the moving demand area 108 may be analyzed, e.g. by the traffic analyzing unit of the one or more support units 164 discussed above. For example traffic from wireless devices 120, 121, with reference to FIGS. 3-4, may be analyzed to find digital content that it is an actual and/or likely demand for. To find wireless devices located in the moving demand area 108, location information and/or location services available in the cellular communications network 100 may be used, e.g. via the position identifying unit of the one or more support units 164 discussed above. Change of location of wireless devices. e.g. wireless device 120, 121, found to be located in the moving demand area 108 at an initial location of the moving demand area 108, may be identified this way. The result may then be compared to the movement pattern for a period of time to be able to with greater certainty identify wireless devices, e.g. wireless devices 120, 121, that are located in and are moving with the moving demand area 108. A situation found through the analyzing may then be compared to a historical situation with a known demand for digital content by wireless devices in a previous similar situation, e.g. on a corresponding train or road, such as same time different day and/or moving according to a corresponding movement pattern. Alternatively the historical situation may be trusted and used directly without analyzing anything in real time. The historical demand may be found by analyzing digital contents that previously have been requested and/or delivered to wireless devices.

The identified demand may thus base on an actual demand identified for wireless devices, e.g. wireless devices 120, 121, located in the moving demand area 108 partly or wholly during movement according to the movement pattern. The demand may have been identified based on analyzing content of wireless device traffic in the moving demand area 108 during movement according to the movement pattern, e.g. at the start of the movement and/or along the way from start to end or part thereof. For example, multiple wireless devices identified to request the same digital content, e.g. a certain web radio transmission, in the moving demand area 108 may be used to identify the actual demand and thus result in provision of the digital content in the provision area 170.

Alternatively, or in addition, the demand may be based on a likely demand, e.g. based on statistical and/or historical data. Such data may be produced by analyzing traffic from e.g. wireless devices that previously have been located in the demand area and/or moved according to the movement pattern and/or wireless devices that have some other thing in common with actual wireless devices identified to be present in the moving demand area, e.g. the wireless devices 120, 121. Identifying the likely demand may involve identifying user profiles or similar of the actual wireless devices, e.g. wireless devices 120, 121 and compare with historical data from other wireless devices of similar or same user profiles. It may also be so that certain user profiles as such indicate that there will be a real or likely demand for certain digital content, without the need of analyzing traffic relating to wireless devices presently located in the moving demand area 108, such as wireless devices 120, 121. The respective user profile may base on or be affected by one or more applications and/or settings that a user, associated with a respective user profile, may have activated in his/hers wireless device, e.g. that certain digital content when available shall automatically be downloaded.

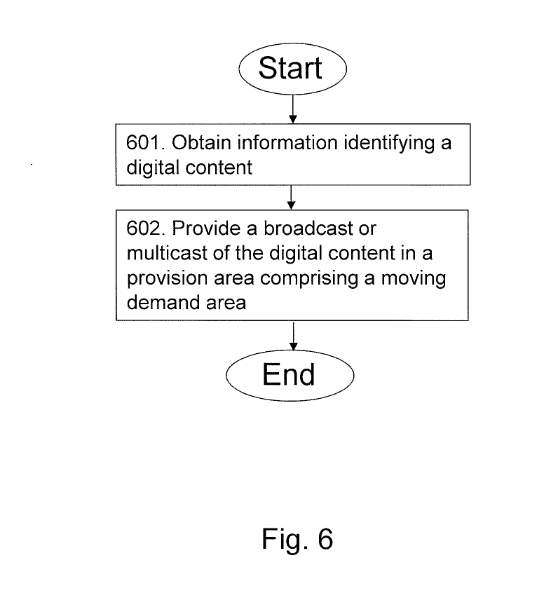

Embodiments herein relating to a method in a communication node 700 for providing a digital content to at least one wireless device, such as wireless devices 120, 121, in the cellular communications network 100 will now be further elaborated and described with reference to the flowchart depicted in FIG. 6. The communication node 700 may correspond to the broadcast manager 163 alone or in combination with all or some of the one or more support units 164 and/or the BMSC 161, just to give some examples in view of the above. The method comprises the following actions, which actions may be taken in any suitable order. Further, actions may be combined.

Action 601

The communication node 700 obtains information identifying the digital content. The digital content is associated with the moving demand area 108 that is an area that changes location over time according to the movement pattern and in which area a demand for the digital content has been identified to move with the area. The moving demand area 108 and the provision area 170 typically has constant size and shape during movement according to the movement pattern.

In some embodiments the moving demand area 108 covers, and the movement pattern is along, infrastructure for transport, for example railways and/or roads.

In some embodiments the movement pattern is based on timing information relating to transport using the infrastructure. The timing information may be predetermined, such as known time schedules, and/or real or nearly real time updated timing information, such as updated time schedules and/or observations relating to a present situation. The latter may involve observing position of wireless devices known to be located in the moving demand area and then the movement pattern may be updated accordingly.

In some embodiments the identified demand is based on an actual demand associated with wireless devices, such as wireless devices 120, 121, located in the moving demand area 108 partly or wholly during movement according to the movement pattern. The actual demand may be based on requests for the digital content made by, and/or based on user profiles associated with, said wireless devices, such as wireless devices 120, 121, located in the moving demand area 108.

In some embodiments the identified demand is based on a likely demand associated with the moving demand area 108. The likely demand may be based on a statistical and/or historical demand associated with the demand area 108. Further, the likely demand may be based on user profiles associated with wireless devices 120, 121 identified to be located in the moving demand area 108 partly or wholly during movement according to the movement pattern.

This action may correspond fully or partially to the previously described Action 501.

Action 602

The communication node 700 provides, based on the obtained information, a broadcast or multicast of the digital content in the provision area 170 that comprises the moving demand area 108. The provision area 170 corresponds to one or more cells, such as cells 115-118, served by one or more base stations, such as base stations 110-113, that are broadcasting or multicasting the digital content. The provided broadcast or multicast is adapted based on the movement pattern to thereby enable the at least one wireless device, such as wireless devices 120, 122, when located in and moving with the moving demand area 108, to receive the digital content by the broadcast or multicast.

In some embodiments the adaptation of the provided broadcast or multicast in the provision area 170 comprises change of bandwidth allocated for the provided broadcast or multicast in said one or more cells, e.g. cells 115-118. This so that there is higher allocated bandwidth for a cell thereof when it is at least partly covered by the demand area 108 and lower allocated bandwidth for a cell thereof when it is not covered by the demand area 108.

In some embodiments the adaptation of the provided broadcast or multicast in the provision area 170 comprises change of said one or more cells, e.g. cells 115-118, by inclusion or exclusion, so that the provision area 170 thereby moves with the demand area 108.

This action may correspond fully or partially to the previously described Actions 502-504.

Hence, the method provides the digital content to the at least one wireless device 120, 121 being located in and moving with the moving demand area 108. The obtained information may be seen as identifying the digital content as a digital content associated with the moving demand area 108.

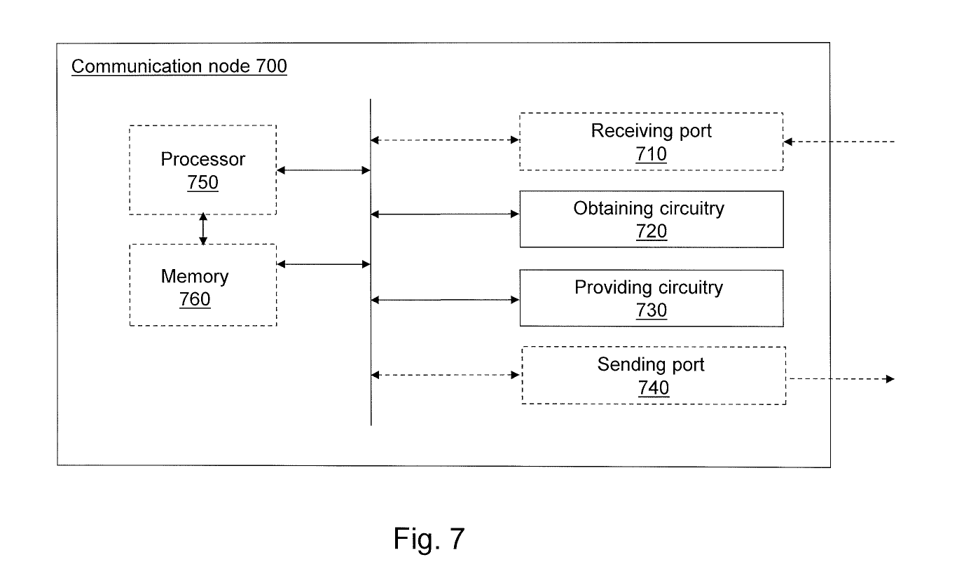

To perform the actions above for providing the digital content to the at least one wireless device, e.g. wireless devices 120, 121, in the cellular communications network 100, the communication node 700 may comprise an arrangement schematically depicted in FIG. 7.

The communication node 700 comprises an obtaining circuitry 720, configured to obtain the information identifying the digital content that is associated with the moving demand area 108.

The communication node 700 further comprises a providing circuitry 730, configured to, based on the obtained information, provide the broadcast or multicast of the digital content in the provision area 170.

The communication node 700 may further comprise a receiving port 710 that may be configured to receive information from and be involved in communication with other units, e.g. the BMSC 161 and the one or more support units 164.

The communication node 700 may further comprise a sending port 740 that may be configured to send information to and be involved in communication with other units, e.g. the BMSC 161 and/or the one or more support units 164.

The embodiments of the communication node 700 may be implemented through one or more processors, such as a processor 750 in the communication node 700 depicted in FIG. 7, together with computer program code for performing the functions and actions of embodiments herein. In some embodiments the circuitry discussed above may be fully or partially implemented by the processor 750.

The computer program code mentioned above may also be provided as a computer program product, for instance in the form of a data carrier carrying computer program code for performing the embodiments herein when being loaded into the in the communication node 700. One such carrier may be in the form of a CD or DVD. It is however feasible with other data carriers such as a memory stick, memory card or hard drive. The computer program code may furthermore be provided as pure program code on a server for download to the communication node 700. The computer program code may furthermore be provided in the form of a data file or files on, or available through, a server for download. The file or files may be executable files for direct or indirect download to and execution on the communication node 700, or may be for intermediate download and compilation to make them executable before download to and for execution in the communication node 700. The server may be accessible over a computer network, such as the Internet, and may e.g. be a web or ftp server.

The communication node 700 may further comprise a memory 760 comprising one or more memory units. The memory 760 is arranged to store data, such as values mentioned above relating to configuration/s and/or the instructions/s that may be sent to the BMSC 161 and/or the one or more support units 164, and/or to the measures and parameters for the decision, etc., and configurations and/or applications to perform the method when being executed in the communication node 700.

Those skilled in the art will also appreciate that the circuitry and ports 710-740 may refer to a combination of analog and digital circuits, and/or one or more processors configured with software and/or firmware (e.g., stored in memory) that, when executed by the one or more processors such as the processor 750, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Many embodiments and examples that have been described and discussed herein relate to a LTE-based cellular communications network, and in particular a cellular communications network that has been enhanced with MBMS functionality, such as eMBMS. However, although it has been shown that embodiments herein are compatible with and may advantageously be implemented in such networks, this is not to be construed as limiting embodiments herein to only such networks. Generally, embodiments herein are not limited to the above described embodiments. Various alternatives, modifications and equivalents may be used. Therefore, the above embodiments should not be taken as limiting the scope of the invention, which is defined by the appending claims.

When using the word “comprise” or “comprising” it shall be interpreted as non-limiting, i.e. meaning “consist at least of”.

1. A method in a communication node for providing a digital content to at least one wireless device in a cellular communications network comprising:
obtaining information identifying the digital content, the digital content being associated with a moving demand area being an area that changes location over time according to a movement pattern and in which area a demand for the digital content has been identified to move with the area; and
providing, based on the obtained information, a broadcast or multicast of the digital content in a provision area comprising the moving demand area, the provision area corresponding to one or more cells served by one or more base stations broadcasting or multicasting the digital content, wherein the provided broadcast or multicast is adapted based on the movement pattern to thereby enable the at least one wireless device, when located in and moving with the moving demand area, to receive the digital content by the broadcast or multicast.

2. The method as claimed in claim 1, wherein the adaptation of the provided broadcast or multicast in the provision area comprises change of bandwidth allocated for the provided broadcast or multicast in said one or more cells so that there is higher allocated bandwidth for a cell thereof when it is at least partly covered by the demand area and lower allocated bandwidth for a cell thereof when it is not covered by the demand area.

3. The method as claimed in claim 1, wherein the adaptation of the provided broadcast or multicast in the provision area comprises change of said one or more cells by inclusion or exclusion, so that the provision area thereby moves with the demand area.

4. The method as claimed in claim 1, wherein the moving demand area covers, and the movement pattern is along, infrastructure for transport.

5. The method as claimed in claim 4, wherein the movement pattern is based on timing information relating to transport using the infrastructure.

6. The method as claimed in claim 1, wherein the identified demand is based on an actual demand associated with wireless devices located in the moving demand area partly or wholly during movement according to the movement pattern.

7. The method as claimed in claim 6, wherein the actual demand is based on requests for the digital content made by, and/or based on user profiles associated with, said wireless devices located in the moving demand area.

8. The method as claimed in claim 1, wherein the identified demand is based on a likely demand associated with the moving demand area.

9. The method as claimed in claim 8, wherein the likely demand is based on a statistical and/or historical demand associated with the demand area.

10. The method as claimed in claim 7, wherein the likely demand is based on user profiles associated with wireless devices identified to be located in the moving demand area partly or wholly during movement according to the movement pattern.

11. A broadcast management unit for providing a digital content to at least one wireless device in a cellular communications network comprising:
an obtaining circuitry, configured to obtain information identifying the digital content, the digital content being associated with a moving demand area being an area that changes location over time according to a movement pattern and in which area a demand for the digital content has been identified to move with the area; and
a providing circuitry, configured to, based on the obtained information, provide a broadcast or multicast of the digital content in a provision area comprising the moving demand area, the provision area corresponding to one or more cells served by one or more base stations broadcasting or multicasting the digital content, wherein the provided broadcast or multicast is adapted based on the movement pattern to thereby enable the at least one wireless device, when located in and moving with the moving demand area, to receive the digital content by the broadcast or multicast.

12. The communication node as claimed in claim 11, wherein the adaptation of the provided broadcast or multicast in the provision area comprises change of bandwidth allocated for the provided broadcast or multicast in said one or more cells so that there is higher allocated bandwidth for a cell thereof when it is at least partly covered by the demand area and lower allocated bandwidth for a cell thereof when it is not covered by the demand area.

13. The communication node as claimed in claim 11, wherein the adaptation of the provided broadcast or multicast in the provision area comprises change of said one or more cells by inclusion or exclusion, so that the provision area thereby moves with the demand area.

14. The communication node as claimed in claim 11, wherein the moving demand area covers, and the movement pattern is along, infrastructure for transport.

15. The communication node as claimed in claim 14, wherein the movement pattern is based on timing information relating to transport using the infrastructure.

16. The communication node as claimed in claim 11, wherein the identified demand is based on an actual demand associated with wireless devices located in the moving demand area partly or wholly during movement according to the movement pattern.

17. The communication node as claimed in claim 16, wherein the actual demand is based on requests for the digital content made by, and/or based on user profiles associated with, said wireless devices located in the moving demand area.

18. The communication node as claimed in claim 11, wherein the identified demand is based on a likely demand associated with the moving demand area.

19. The communication node as claimed in claim 18, wherein the likely demand is based on a statistical and/or historical demand associated with the demand area.

20. The communication node as claimed in claim 17, wherein the likely demand is based on user profiles associated with wireless devices identified to be located in the moving demand area partly or wholly during movement according to the movement pattern.
